(19) United States
(12) Patent Application Publication
(10) Pub. No.: US 2009/0106946 A1
(43) Pub. Date: Apr. 30, 2009

(54) Golf Scorecard Holder

(76) Inventor: Richard Clinton Brewer, JR., Jacksonville, FL (US)

Correspondence Address: AKERMAN SENTERFITT, P.O. BOX 3188, WEST PALM BEACH, FL, 33402-3188, US

(21) Appl. No.: 11/926,599

(22) Filed: Oct. 29, 2007

(51) Int. Cl. B25B 5/04

(52) U.S. Cl. 24/67.5

(57) ABSTRACT

A golf scorecard holder comprising a generally cylindrical base and a clipboard. The cylindrical base comprises a lower portion so dimensioned as to securely fit within a standard vehicle cup holder and an upper portion. The upper portion of the cylindrical base has a first diameter throughout the upper portion. The clipboard is attached to the base at an end of the upper portion of the cylindrical base. The clipboard is positioned on the base at an angle less than ninety degrees to a bottom rim of said base.

### FIELD OF INVENTION

The present invention relates to a golf scorecard holder and particularly to a holder in the form of a clipboard that can be supported by a vehicle cup holder or otherwise attached to a golf cart.

### BACKGROUND OF INVENTION

During a game of golf, the players keep track of their scores on a scorecard. Usually a golf scorecard is a pre-printed form provided on stiff paper or cardboard that may be folded to approximately international size A6. The scorecard may be written upon using a pencil. Golfers often secure their scorecards to a built-in clip found on the steering wheel of golf carts. Writing scores while the scorecard is clipped to the steering wheel poses a challenge, because golf cart drivers cannot simultaneously write and prudently drive the golf cart Golfers prefer not to write scores while parked at a hole that they have just played, because golf etiquette requires that golfers drive away from a hole as soon as possible to allow the hole to the next party to play the hole. Passengers in the golf cart cannot typically keep score because they cannot reach the scorecard when it is clipped to the steering wheel. It is known to clip golf scorecards onto golf club bags, but while the cart is being driven, golf club bags are typically stored at the back of the cart and are thus not accessible. Hence, there exists a need for a clipboard that can be secured to the golf cart and allows golfers to prudently drive the cart and quickly depart from holes recently completed. The present invention meets this need by enabling a golf cart passenger to keep score while the cart is in motion.

### SUMMARY OF INVENTION

One aspect of the present invention relates generally to a golf scorecard holder that can be supported by a vehicle cup holder. The holder comprises a generally cylindrical base and a clipboard. The cylindrical base comprises an upper portion and a lower portion so dimensioned as to securely fit within a standard vehicle cup holder. The upper portion of the cylindrical base has a first diameter throughout. The clipboard is attached to the base at an end of the upper portion. The clipboard is positioned on the base at an angle less than ninety degrees to a bottom rim of the base. The holder can thus easily be inserted into a standard cup holder and written upon while the golf cart is being driven.

In one arrangement, the vehicle is a golf cart and the clipboard is sized to receive a golf scorecard thereon. The clipboard may be sized to accommodate a standard golf scorecard folded in half.

The lower portion of the cylindrical base may be tapered, to fit within a tapered cup holder. Alternatively, the lower portion may have a second diameter throughout said lower portion equal to said first diameter.

The base can have a smallest diameter of 2.0″ such that the holder can support an amount of force reasonably applied to the clipboard when a person writes thereon.

The holder may in some arrangements include at least one prong extending from a back side of said clipboard. The clipboard can include a skirt around a perimeter of a writing surface. A rear surface can be attached to an edge of the skirt opposite the writing surface such that an enclosure is formed, with the base attached to the rear surface, and with the writing surface movably attached by pivot, hinge, or rotation means, such that a user can open the enclosure.

The holder may include a through hole, through which a screw may be inserted to affix said holder to a screw hole in a vehicle.

The base may curve in an amount approximately equal to the angle that the clipboard is positioned relative to the bottom of the base. Alternatively, the base may be substantially straight and the upper portion thereof can include a wedge-shaped end.

The holder can include a pencil sharpener, and/or a means for holding writing instruments. In some arrangements, a circular cover may be connected to the bottom rim. The circular cover can include a portion that is movably connected to said bottom rim.

In another aspect of the invention, a kit can include the holder and a screw for securing the holder to a screw hole in a vehicle such as a golf cart. The kit can include a device including (i) a through hole, through which the screw may be inserted so as to join the device to a screw hole in a vehicle, and (ii) a cylindrical portion to which the holder may be removably attached. In this arrangement, the holder can thus be secured to the vehicle without occupying a cup holder.

### BRIEF DESCRIPTION OF THE DRAWINGS

There is shown in the drawings embodiments which are presently preferred, it being understood however that the invention is not limited to the precise arrangements shown.

FIG. 1 shows a side perspective view of a golf scorecard holder in accordance with an aspect of the present invention.

FIG. 2 shows a side perspective view of the golf scorecard holder of FIG. 1.

FIG. 3 shows a side perspective view of the golf scorecard holder of FIG. 1.

FIG. 4 shows a bottom perspective view of the golf scorecard holder in accordance with another aspect of the present invention.

FIG. 5 shows a side perspective view of the golf scorecard holder in accordance with another aspect of the present invention.

FIG. 6 shows a top plane view of the golf scorecard holder in accordance with another aspect of the present invention.

FIG. 7 shows a top perspective view of the golf scorecard holder in accordance with another aspect of the present invention.

FIG. 8 shows a side perspective view of the golf scorecard holder in accordance with another aspect of the present invention.

### DETAILED DESCRIPTION

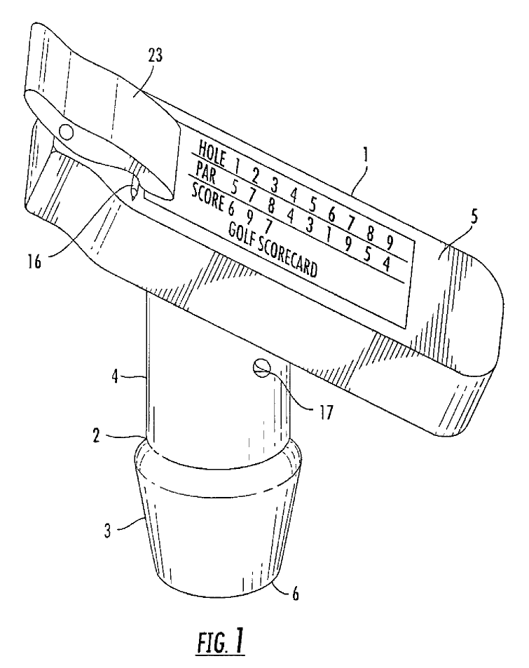

The present invention can best be understood by referring to the drawings, in which a golf scorecard holder 1 according to several aspects of the present invention is shown. FIG. 1 is a side perspective view of the holder 1. The holder 1 includes a generally cylindrical base 2 and a clipboard 5. The base 2 may have an approximately equal diameter and thickness throughout.

The base 2 includes an upper portion 4 having an approximately equal diameter throughout. The clipboard S is attached to an end of the upper portion 4 such that the clipboard sits at an angle of less than ninety degrees to a bottom rim 6 of the base 2.

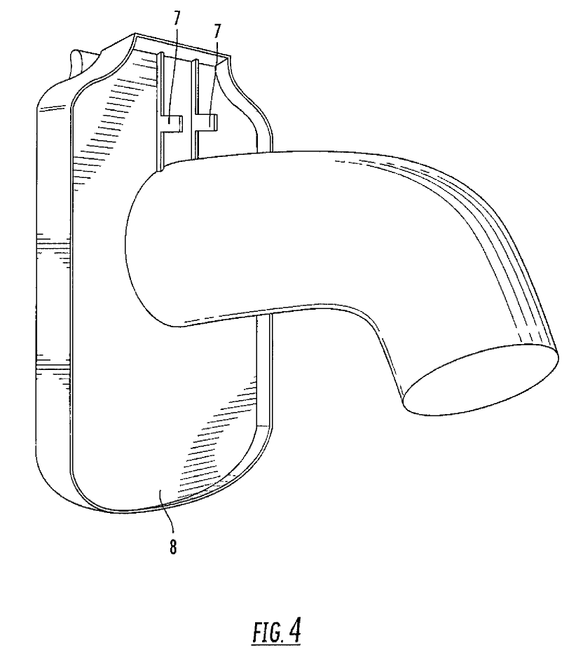

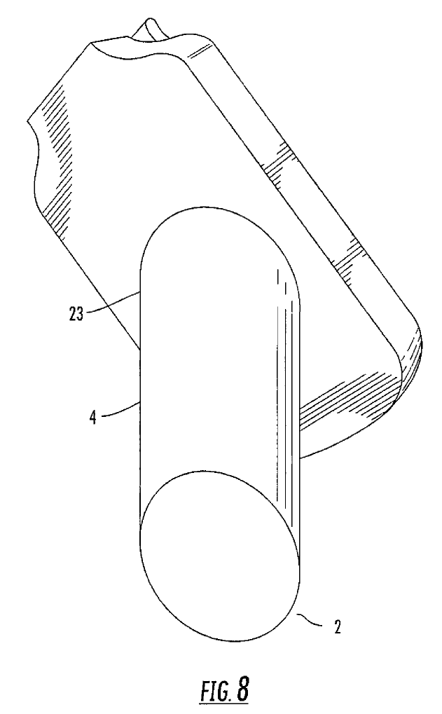

The angle of the clipboard 5 to the bottom rim 6 may be achieved by several means. The base 2 may be straight and have a wedge-shaped end 23 of the upper portion 4 of the base 2, as shown in FIG. 8. Alternatively, the base 2 may be curved and have a flat end 23 connected to the clipboard 5. The base may only be curved in one portion and further comprise straight segments. If the base curves and has a flat end 23, the base can curve in an amount equal to the angle which the clipboard 5 forms with the bottom rim 6, as shown in FIG. 4.

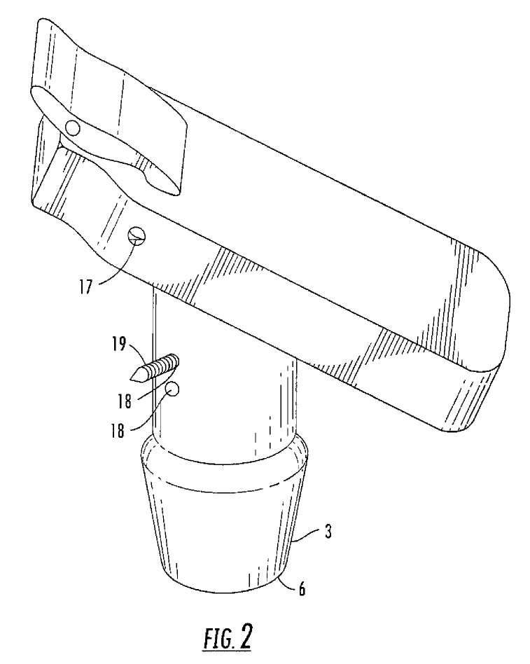

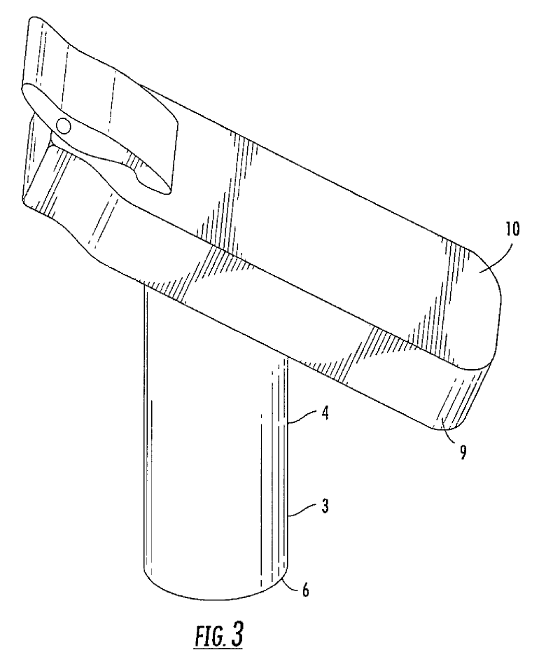

A lower portion 3 of the base 2 is sized to securely fit into a standard vehicle cup holder, for example provided on a standard golf cart. As shown in FIG. 2, the lower portion 3 may be tapered, in that the diameter of the lower portion 3 may gradually decrease toward the bottom rim 6. A tapered lower portion 3 can allow the holder 1 to securely fit within cup holders having a range of sizes. Alternatively as shown in FIG. 3, the lower portion 3 may have a single diameter throughout.

The structure of the holder 1 provides adequate support to allow the clipboard 5 to remain steady when a user is using the clipboard as a writing surface. The base generally may have any diameter and thickness great enough to support an amount of source reasonably applied to the clipboard when a person uses the clipboard as a writing surface. Further, at least the lower portion 3 of the base 2 should have a diameter approximately equal to the diameter of vehicle cup holders. More specifically, the diameter of the base may be about 2″ or greater, about 2.5″ or greater, or about 3″ or greater. The diameter of the lower portion may be greater than the diameter of the upper portion, or the diameter of the upper portion may be greater than the diameter of the lower portion. The thickness of the wall of the base 2 may also be selected to provide strength to the holder 1. For example, the wall may have a thickness of 0.1875″. Cup holders may have a depth of approximately 1″ to 3″, or more specifically 1.5″ to 2″. The length of the lower portion 3 may be equal to, less than, or greater than the depth of standard vehicle cup holders.

In one embodiment shown in FIG. 4, the holder may be further supported by at least one prong 7 on a back side 8 of the clipboard. The holder may further comprise two or more prongs 7 on the back side 8 of the clipboard 5. The prongs 7 preferably protrude from the back side at an angle of less than about ninety degrees to the direction at which the base 2 extends from the back side 5. In one embodiment, the prongs are parallel to the base and protrude at ninety degrees from the clipboard back side 8 of the clipboard 5.

The angle of the clipboard 5 to the bottom rim 6 serves to facilitate writing when the holder is secured within a cup holder or screwed to the golf cart. The clipboard 5 may be positioned in relation to the bottom rim 6 at an angle of approximately thirty to eighty degrees; more specifically, approximately forty-five to seventy degrees; or more specifically again, approximately fifty-five to sixty-five degrees.

The holder 1 may be made of any suitable material, although the holder is preferably made of plastic or metal. The holder may be manufactured as one integral unit, or as several pieces that are joined together. The materials used for the base may be rigid or flexible enough to permit a user to adjust the angle of the clipboard. The base 2 is preferably hollow, but it may be solid.

In one embodiment, the clipboard 5 is sized appropriately to receive a golf scorecard. It should be understood that the present invention is not limited to any particular dimensions as the dimensions of golf scorecards may vary. However, golf scorecards typically have heights ranging from approximately 4″ to 6″ and lengths ranging from approximately 8″ to 12″ and are typically folded in half to have a height of approximately 5″ and a width of approximately 4″. Alternatively, golf scorecards may have the dimensions of international standard A6 or A5 paper. The clipboard should have a height and width slightly greater than the scorecard so as to reasonably accommodate the card. In one embodiment, the clipboard is sized appropriately to receive a golf scorecard that has been folded in half, particularly folded in half lengthwise. For example, the clipboard 4 may have a width of about 4.75″ and a length of about 6″.

As shown in FIG. 3, the aesthetics of the clipboard may be varied to include a skirt 9 attached to the clipboard around a perimeter of a writing surface 10 forming a front side to the clipboard 5. The skirt 9 may have any length, but more specifically, may range from about 0.5″ to about 2″. The skirt 9 may be integrally connected to the writing surface 10 at approximately ninety degrees. The skirt can hide the connection of the cylindrical base 2 to the back side of the clipboard 5. The perimeter of the writing surface 10 may also have rounded edges, to add comfort to users of the holder.

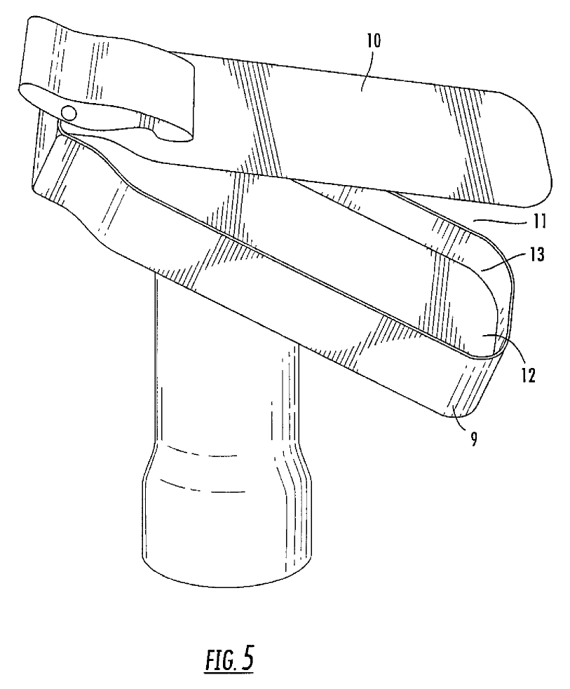

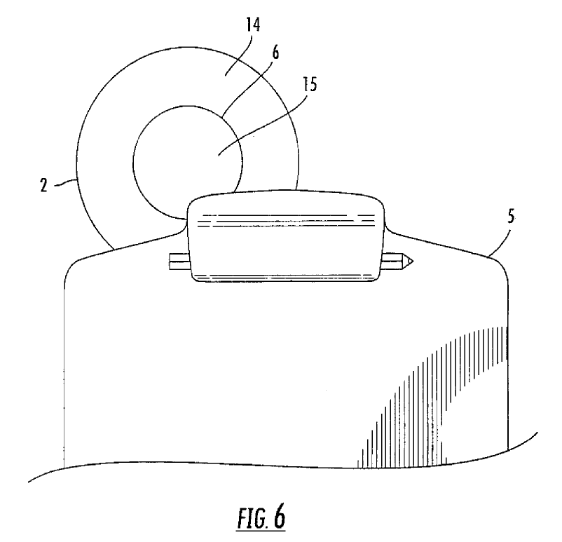

The holder 1 may also be used for storage purposes. In one embodiment shown in FIG. 5, an enclosure 11 can be formed by attaching a rear surface 12 to an edge 13 of the skirt 9 opposite said writing surface 10. In this embodiment, the base 2 can be attached to the rear surface 12. In order to access the enclosure, the writing surface can be movably attached, such as by pivot, hinge, or rotation means to the skirt 9. Writing instruments and additional scorecards are examples of items which may be stored in the enclosure 11. As shown in FIG. 6, a second storage compartment 14 may also be formed by pivotally or removably attaching the clipboard 5 to the base 2 and further securing a circular cover 15 to the bottom rim 6.

A writing instrument may also be stored by securing the instrument with the clip 24 of the clipboard 5. The clip 24 may be spring loaded. The clip may have a width equal to or less than the width of the clipboard 5. The clip may be made of plastic or metal. As shown in FIG. 1, the clip 24 of the clipboard my have a curved area 16, so as to better hold a writing instrument. The holder may further include a pencil sharpener 17, which may either be attached to the base or to the clipboard.

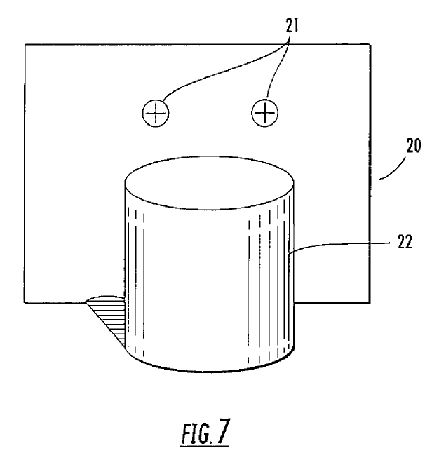

The holder 1 may be hand-carried by users, may be secured within a cup holder, or may be secured to a vehicle, such as a golf cart. As shown in FIG. 2, the holder 1 therefore may contain one or more holes 18 through which a screw 19 or other fastener may be inserted to secure the holder to a vehicle such as a golf cart. The holder may also be part of a kit, in which one or more screws are provided to connect the holder to a vehicle such as a golf cart. A kit may also include instructions for connecting the holder to the vehicle. In a farther embodiment, the kit may also contain a separate device 20 shown in FIG. 7 that has at least one screw hole 21 and a cylindrical portion 22. The separate device 20 may be secured with a screw through its screw hole 21 to the vehicle. Further, the holder 1 may be removably attached to the cylindrical unit 22. For instance, the base 2 of the holder 1 may fit securely as a female pipe over the cylindrical until 22. Alternatively, the base 2 of the holder 1 may fit securely within the cylindrical unit 22. Either kit would provide an alternative for golf carts that have no cup holder or for golfers who wish to maintain their cup holders free for drinks.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

I claim:

1. A golf scorecard holder comprising:
a generally cylindrical base comprising a lower portion so dimensioned as to securely fit within a vehicle cup holder and an upper portion having a first diameter throughout said upper portion; and
a clipboard attached to the base at an end of said upper portion,
wherein the clipboard is positioned on the base at an angle less than ninety degrees relative to a bottom rim of said base.

2. The holder of claim 1, wherein said vehicle is a golf cart and wherein said clipboard is sized to receive a golf scorecard thereon.

3. The holder of claim 1, wherein the clipboard is sized to accommodate a standard golf scorecard folded in half.

4. The holder of claim 1 wherein said lower portion is tapered.

5. The holder of claim 1 wherein said lower portion has a second diameter throughout said lower portion equal to said first diameter.

6. The holder of claim 1 wherein said base comprises a smallest diameter of 2.0″ such that the holder can support an amount of force reasonably applied to the clipboard when a person writes thereon.

7. The holder of claim 1, further comprising at least one prong extending from a back side of said clipboard.

8. The holder of claim 1, wherein said clipboard further comprises a skirt around a perimeter of a writing surface.

9. The holder of claim 8 wherein a rear surface is attached to an edge of said skirt opposite said writing surface such that an enclosure is formed,
wherein said base is attached to said rear surface, and
wherein said writing surface is movably attached by pivot, hinge, or rotation means, such that a user can open said enclosure.

10. The holder of claim 1, further comprising a through hole, through which a screw may be inserted to affix said holder to a screw hole in a vehicle.

11. The holder of claim 1 wherein said base curves in an amount approximately equal to said angle.

12. The holder of claim 1 wherein said base is substantially straight and said upper portion comprises a wedge-shaped end.

13. The holder of claim 1, further comprising a pencil sharpener.

14. The holder of claim 1, further comprising a means for holding writing instruments.

15. The holder of claim 1, further comprising a circular cover connected to said bottom rim.

16. The holder of claim 15, wherein said circular cover comprises a portion that is movably connected to said bottom rim.

17. A kit comprising the holder of claim 1 and a screw for securing the holder to a screw hole in a vehicle.

18. A kit according to claim 17 further comprising a device, wherein said device comprises (i) a through hole, through which the screw may be inserted so as to join the device to a screw hole in a vehicle, and (ii) a cylindrical portion to which the holder of claim 1 may be removably attached.
